(19) United States
(12) Patent Application Publication
(10) Pub. No.: US 2004/0241623 A1
(43) Pub. Date: Dec. 2, 2004

(54) Method for enabling at least a user, inparticular a blind user, to perceive a shape and device therefor

(76) Inventors: Charles Lenay, Compiegne (FR); Olivier Gapenne, Mont Saint-Aignan (FR); Sylvain Hanneton, Creteil (FR); Catherine Marque, Margny-Les-Compiegne (FR); Clothilde Vanhoutte, Compiegne (FR)

Correspondence Address: IP DEPARTMENT OF PIPER RUDNICK LLP, ONE LIBERTY PLACE, SUITE 4900, 1650 MARKET ST, PHILADELPHIA, PA, 19103, US

(21) Appl. No.: 10/493,263

(22) PCT Filed: Oct. 28, 2002
(86) PCT No.: PCT/FR02/03699

(30) Foreign Application Priority Data
Oct. 26, 2001 (FR) 01/13897

(51) Int. Cl. G09B 21/00

(52) U.S. Cl. 434/112

(57) ABSTRACT

A method enabling at least one blind user to perceive a form using at least one sensory stimulator including creating at least one virtual sensor having a multiplicity of analysis fields; displacing the virtual sensor with a pointing device on or towards the form; and controlling a sensitive element of the sensory stimulator with each analysis field to enable perception of the form with the sensory stimulator by modifying the state of each sensitive element; and a device for implementing the method, including a computer with a memory in which the form is contained, the computer being optionally associated with a display screen; a pointing device; and at least one sensory stimulator.

The present invention pertains to the field of form perception.

The present invention pertains more particularly to a method enabling at least one user, notably a blind user, to perceive a form or a graphic representation, the method using at least one sensory stimulator.

In order to help the blind identify that which they cannot see, it is known to use the creation of tactile or sonorous relief. With regard to tactile material, the base method is of course the method developed by Louis Braille.

There have also been developed Braille terminals composed of at least a row of Braille cells, or multiple rows of Braille cells, each cell being constituted by eight points each of which can move between a retracted position and a raised position. These devices make it possible, for example, to read a book by interpretation of each letter of each word as the letters appear on a cell.

Also known in the prior art are methods enabling the blind to perceive graphic representations by means of a sensory stimulator.

There was developed, for example, in 1941 a device which was the object of the American patent no. U.S. 2,327,222, issued in 1943. This device comprises a certain number of points so as to enable a blind person to perceive a fixed image.

There was also developed in 1954 a device which was the object of Swiss patent no. CH 325 289, published in 1957. This device has as object the enabling of reporting by means of mobile points a relief perceived by a set of sensors.

At present, in the field of tactile stimulators, it is possible to position up to 400 adjacent mobile points so as to form an equivalent in relief of the captured form.

The experts in the field are at present attempting to increase the resolution of the sensory stimulators by augmenting the number of mobile points in order to enable enhanced perception of forms. The major drawback of this approach is that it leads to the creation of material that is increasingly complex and increasingly expensive.

Moreover, none of the devices designed at present make possible an interactivity of the user enabling him to move into the perceived virtual space.

The present invention is based on progress in a totally opposite direction from that of the present advances of the expert in the field.

In fact, rather than attempt to increase the number of points, it was found surprisingly that it was possible to enable perception of forms by using simple, inexpensive stimulators such as those used for reading texts written in Braille.

In order to accomplish this objective, the present invention is of the type described above and it is defined in its broadest sense by the content of claim 1.

According to the invention, there is created a virtual sensor presenting a multiplicity of analysis fields, said sensor being capable of being moved by means of a pointing device on or towards said form, each analysis field controlling a sensitive element of said sensory stimulator so as to enable perception of said form by means of said sensory stimulator by modification of the state of each sensitive element.

The form is a defined form, preferably digital, illustrating any graphic representation of two-dimensional or three-dimensional form.

Said form can be created by said user by means of a virtual drawing tool. A single tool can advantageously enable drawing and reading.

In a particular application of the invention, said form is available via a telecommunication network of the Internet type. In order to achieve this, it is preferable to define the interaction spaces between the virtual sensors and the forms to be perceived. These spaces can be two-dimensional or three-dimensional.

In this application, each user is defined in or on said form by a body sensor and by a body image. It is moreover preferable to define the spaces of structured encounter (virtual halls, displacements between two pieces, etc.).

In a variant of the invention, said sensitive elements are points for the reading of texts in Braille, each of which can move between a retracted position and a raised position, the method according to the invention then consists of driving said sensitive elements into at least one vibrating state in which they oscillate in a regular manner between the retracted position and the raised position, in order to enable nuancing of the perception of said form.

Each of said sensitive element(s) preferably presents a multiplicity of different vibrating states, each vibrating state being associated with a quantitative variable.

When each of said sensitive elements present a multiplicity of vibrating states, each oscillation is preferably associated with a color or a gray level and/or a distance.

The configuration of said virtual sensor is preferably modifiable by modification of the relative position of the analysis fields.

The analysis fields of the virtual sensor preferably present a general matrix, separated or nested form.

Each of said analysis fields preferably presents a configuration of a parallelogram, triangle, circle, portion of a circle, parallelepiped, pyramid, sphere or portion of a sphere.

The present invention also pertains to a device for the implementation of the method according to the invention, comprising a computer comprising a memory in which said form is contained, said computer being possibly associated with a display screen, said device moreover comprising a pointing device as well as at least one sensory stimulator.

Said pointing device and/or said virtual drawing tool is or are constituted preferably by a stylus associated with a graphic tablet or a joystick or a trackball or a virtual reality data garment.

Said sensory stimulator can be a tactile stimulator comprising between 1 and 80 points and/or a sonorous stimulator and/or a visual stimulator.

The present invention thus advantageously enables by means of a simple sensory stimulation device the perception of any form by gradually discovering it, by enlarging it or reducing it, etc.

The present invention also advantageously enables multiple users to communicate via a telecommunication network by exchanging forms or discovering a form together or a unique graphic representation such as, for example, a synthesis landscape made available on said network by means of a server. The method thus enables creation of a veritable interactivity among partially sighted subjects on the same images, notably for remote game playing.

Better comprehension of the invention will be obtained from the description below presented for purely explanatory purposes of a mode of implementation of the invention with reference to the attached figures:

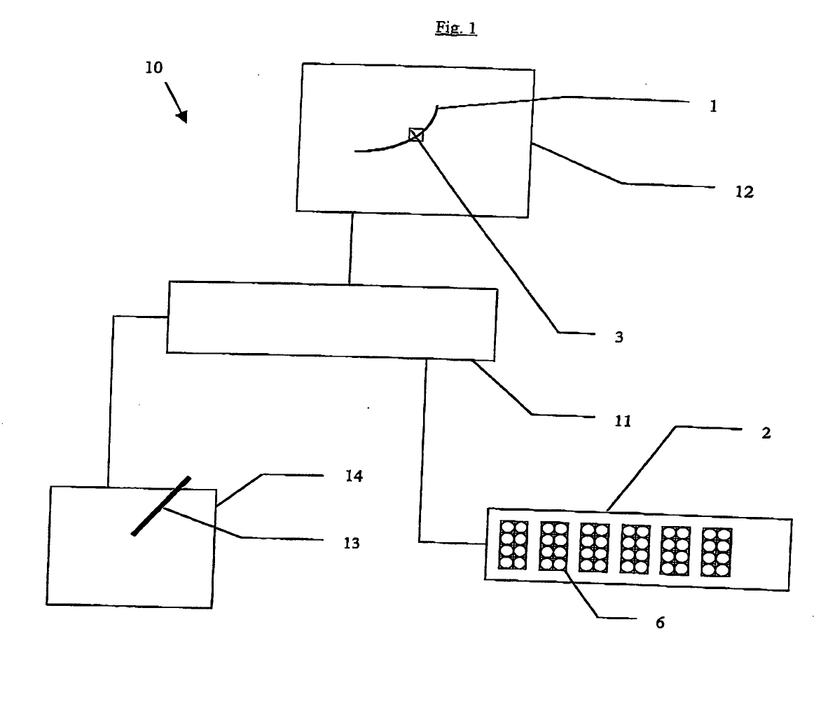

FIG. 1 illustrates a basic diagram of a device enabling implementation of the method;

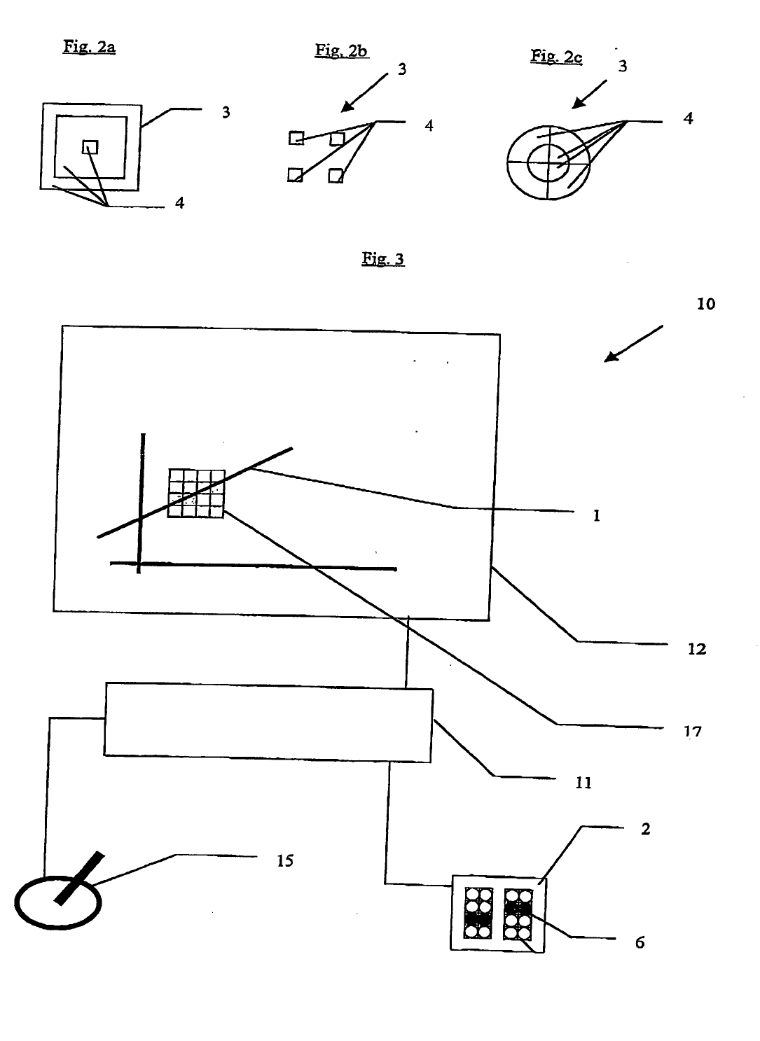

FIGS. 2a, 2b and 2c illustrate examples of composition of virtual sensors;

FIG. 3 illustrates a basic diagram of another device enabling implementation of the method;

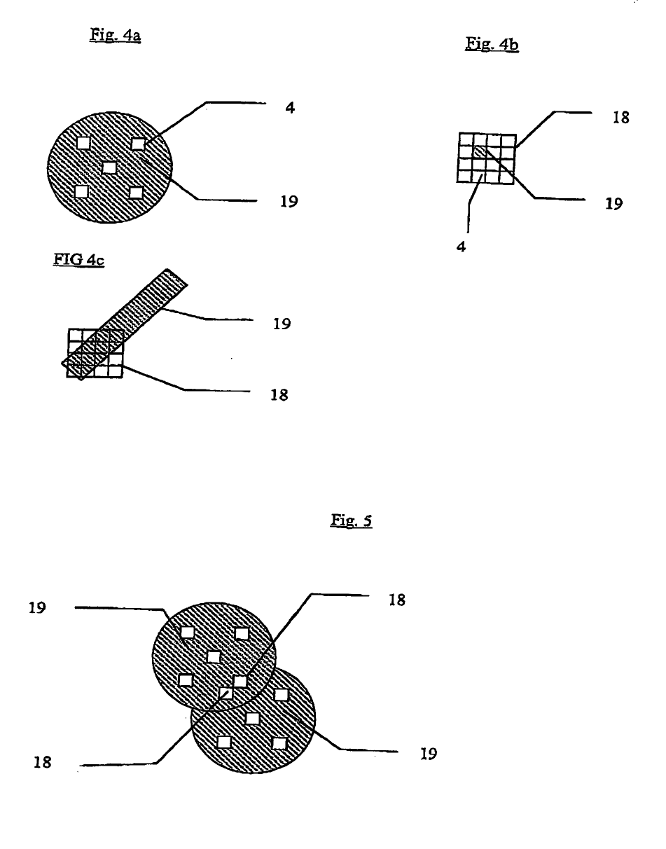

FIGS. 4a, 4b and 4c illustrate three different associations of a body sensor with a body image;

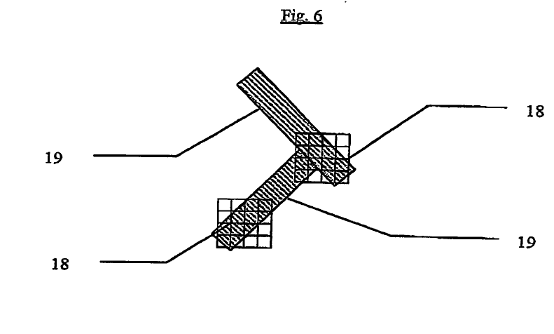

FIG. 5 illustrates a perceptive crossing; and

FIG. 6 illustrates another perceptive crossing.

The method according to the invention, illustrated in FIG. 1, is a method enabling at least one user, notably a blind user, to perceive a form (1), of the type using at least one sensory stimulator (2).

The form (1) is a defined form, preferably digital, illustrating an icon, an image, any two-dimensional or three-dimensional graphic representation or a representation of others.

The sensory substitution systems for the perception of two-dimensional forms have shown their efficacy: blind subjects succeeded after a reasonable learning period in locating the objects and events, and in recognizing their forms.

Nevertheless, the cost and the technical complexity of tactile stimulation devices which enable giving the user directly a perception of the captured forms have represented obstacles which until now have been insurmountable for the diffusion of such systems. The conventional system of 400 distinct points of tactile stimulation represents a specific and elevated investment for blind users.

In contrast, if it is desired to give only several points of tactile sensory input at each instant, the information of location and/or form is not provided directly.

Moreover, although the existing systems enable the perception of two-dimensional forms recorded on plane surfaces, they do not allow at the same time the drawing and writing of new two-dimensional and a fortiori three-dimensional forms. However, the perception and production (reading and writing) of two-dimensional and three-dimensional forms has not only an intrinsic value but is also a useful method for the perceptive learning phase.

According to the invention, there is created a virtual sensor (3) presenting a multiplicity of analysis fields (4), said virtual sensor (3) being capable of being moved by means of a pointing device (5) on or towards said form (1), each analysis field (4) controlling a sensitive element (6) of said sensory stimulator (2) in order to enable perception of said form (1) by means of said sensory stimulator (2) by modification of the state of each sensitive element (6).

In fact, by giving the means of an active, rapid exploration of the perception space by a reduced number of sensory stimulators, one compensates for the weakness of this sensory input by the enrichment of the speed and the possibilities of the action.

The invention thereby implements the bringing into digital relationship (via a software program solution) the actions of the user and his sensory inputs. From there, it is possible to use for the creation of the device (10) enabling the implementation of the method, tactile, visual or auditory stimulation systems which are inexpensive and already available commercially.

The sensory stimulator (2) can be a tactile stimulator comprising, for example, a relatively low number of points (between 1 and 80) or a sonorous stimulator emitting modulated sounds or a visual stimulator emitting light by means, for example, of electroluminescent diodes, or a combination of these different stimulators.

The form (1) is contained in the memory of a computer (11), possibly associated with a display screen (12). This form (1) is generally stored in memory by means of coordinates in the plane or in space.

Said pointing device (5) and/or said virtual drawing tool (7) is/are constituted by a stylus associated with a graphic tablet (14) or a joystick (15) or a virtual reality data garment, or simply a keyboard or a mouse.

The pointing device (5) can control the movements of the virtual movements of the virtual sensor (3) which enables control of the user's sensory input. During the course of activity (movements of the sensors controlled by the pointing devices (5)), the perception of spatial forms (localization and recognition) are constituted in the user's mind.

The pointing device (5) is the means by which the user controls the displacements of the virtual sensor(s) (3). These displacements can be defined in two or three dimensions (or in original dimensionalities ).

There can be multiple pointing devices (5) controlling the displacements of multiple sensors. The pointing devices (5) can enable control of the form even of the virtual sensors (3). Moreover, a pointing device (5) can also control at the same time the displacements of a text recording means modifying the perceived space.

The virtual sensor (3) controls the sensory stimulations as a function of the variations of its environment and thus essentially as a function of its displacements. A sensor is defined by a set of analysis fields (4) which are displaced together. Each analysis field (4) controls a sensory stimulator (2) or an element of a sensory stimulator (2).

The state of the analysis field (4) is defined by the state of the environment covered by this field at the position that it occupies. The number, the disposition, the dimensions and the forms of the analysis fields are parameterizable either at the beginning of transfer for a given use or during the perceptive activity by the action of the specific pointing device (5).

The perceived forms are not given directly and instantaneously to the virtual sensors and tactile stimulators (which would require the ability to produce a veritable tactile image with numerous stimulation points). The forms to be perceived are defined in the digital environment by the complete specification of the effects on the sensory inputs of all of the actions and all of the chains of action (all of the displacements of the analysis fields controlled by the pointing devices (5)). The perceived forms are constituted by the user when he discovers the invariant relations between his actions via the pointing device (5) and his sensations via the sensory stimulators. It was possible to demonstrate that these invariants enable the constitution of a perception of the spatial localization of objects and simple events as well as the perception of their spatiotemporal forms. At the same time, and by means of an activity quite similar to that of perception, the same device enables text recording, the drawing of forms to be perceived. It is sufficient to add a system for triggering a writing system controlled by the user by means of a virtual drawing tool.

In FIG. 1, the pointing device (5) only controls the displacement and rotations of the virtual sensor (3) in a two-dimensional space. The form (1) to be perceived is like a form drawn on the surface of the screen (12) of the computer (11) and the displacements of the virtual sensor (3) correspond to the displacements of the cursor illustrating this virtual sensor (3) on this screen. In this example, the displacements of the cursor are controlled by the stylus (13) of the graphic tablet (14). Depending on the state of the environment under the analysis field of the virtual sensor (3), the software program controls the activation of the points of the block of electronic Braille cells. Here as well, the analysis fields, their number, forms and dispositions are parameterizable either on a one-time basis for specific applications or under the direct control of the user (zoom, change of disposition, etc.).

The configuration of said virtual sensor (3) can be modified by modification of the relative position of the analysis fields (4) by means, for example, of the pointing device (5) or any other control.

The analysis fields (4) of the virtual sensor (3) present a general form:

nested as illustrated in FIG. 2a with three analysis fields (4) controlling three distinct sensitive elements (6) and in FIG. 2c with eight analysis fields (4) organized in circular sectors controlling eight distinct sensitive elements (6) or

separated as illustrated in FIG. 2b with four analysis fields (4) controlling four distinct sensitive elements (6) or

implemented via a matrix as in FIG. 3.

Each of the analysis fields (4) presents a two-dimensional configuration of a parallelogram, triangle, circle, portion of a circle or a three-dimensional configuration of a parallelepiped, pyramid, sphere or portion of a sphere, or a particular case of these (rectangle, cube, etc.).

The analysis fields are defined as a set of three-dimensional elements localized in x, y, z in a displacement space.

The forms to be perceived are defined as a set of three-dimensional elements localized in x, y, z in the same space.

The sensory stimulations are defined at each instant by the state of the interactions between these analysis fields in displacement and the forms to be perceived (which can themselves also be in displacement).

Thus, knowing at input:

the form to perceive, its position and its movements,

the analysis fields, their position and their movements,

the output corresponds to the sensory stimulations to emulate.

In FIG. 3, the software program ensures the coupling between the movements of the joystick (15) enabling the exploration of a space and the tactile stimulations distributed as a function of the virtual forms encountered.

The joystick (15) drives a sensor enabling the exploration of a form that is black (or in color) on a white background displaced on the screen (12) of the computer (11). The virtual sensor (3) corresponds to a matrix (17) of analysis fields (4) (for example, a matrix of 16 fields of 3×3 pixels each). When an analysis field (4) crosses at least one black pixel, it triggers the activation of the retracted sensitive element (6) in the corresponding raised sensitive element (6′) on the Braille box cell.

The tactile stimulation system is explored with the free hand (while the other hand manipulates the joystick). It consists of two contiguous cells of 8 points each, which provides a small matrix of 16 points on a little more than 1 cm². This small matrix is sufficient for the application corresponding to this particular implementation.

This perceptive substitution device thus enables the exploration of a digital tactile image. It has been shown that it enables blind localization, recognition and pursuit by the simple creation of a relationship between the tactile feedback and the exploratory movements performed. The value of such a device is that the relationship between the movements and tactile feedback is purely digital. It can therefore be modified and modulated at will: not only the image can change but also the number, the form and the disposition of the analysis fields.

It should be noted that the rotational orientation of the analysis fields (4) can be controlled. Moreover, the blind user can mobilize a function of passage into writing mode in order to inscribe forms that he learns to recognize.

In accordance with the commercially available Braille systems, the pointing device (5) and the tactile stimulators can either be integrated in the same object (for example, a portable computer for the blind with a mini-joystick) or separated into two or three independent elements.

By bringing his actions into relationship with their sensory feedback, the blind user learns to recognize the position, orientation and form of the explored curves.

In a variant of the invention in which the sensitive elements (6) are points for reading Braille texts, each of which can move between a retracted position and a raised position, each of said sensitive elements (6) furthermore presents at least one vibrating state in which it oscillates in a regular manner between the retracted position and the raised position in order to enable the nuancing of the perception of said form (1).

Said sensitive element(s) (6) can present a single vibrating state, in which case said sensitive element(s) (6) each present three states: two fixed states and an intermediate oscillating state.

Said sensitive element(s) (6) can also present multiple different vibrating states, each vibrating state then being associated with a quantitative variable.

In this case, each of said sensitive elements (6) presents a multiplicity of vibrating states, each oscillation of a sensitive element (6) or of a set of sensitive elements (6) is then associated, depending on the case, with a color or a gray level and/or a distance.

All of the perceptive assistance systems were developed for isolated subjects with sensory handicaps. They provide, for example, blind subjects with the ability to perceive elements from the world of the sighted but do not deal with the question of remote interaction of various blind users, interaction on their respective positions and on text shared in a common space.

Moreover, the conventional sensory substitution systems claim to give blind subjects a perception resembling vision. They do not capitalize on the originality inherent in the new perceptive modality that they produce. In contrast, by recognizing the originality of the perceptive experience created, it is possible to conceive new uses of these systems for a larger public than that comprised of subjects with sensory handicaps.

Finally, the present virtual reality systems can provide encounters between the body images (avatars) of multiple users but they do not allow veritable crossings of glances because there are not crossings of perceptive activities themselves.

Thus, in a particular application of the invention said form (1) is available via a telecommunication network of the Internet type.

Systems dedicated to the active perception of spatial forms in digital spaces (i.e., virtual spaces) enable at the same time the installation of a device of original interaction. To the extent to which these interface systems make possible the active construction of spatial perceptions, they enable at the same time the construction of virtual spaces of perceptive encounters. The networking (either by direct cabling or via the Internet) of a multiplicity of these systems enables the creation of spaces for encounters and perceptive interaction: the manner in which for each user his sensory inputs are defined as a function of his displacements in a perception space depends on the position and the form of the body of other users present in the same space. Each user is defined in the system by a body-sensor (18) and by a body-image (19).

The body-sensor (18), illustrated in FIG. 4a, corresponds to the organization of the analysis fields (4) of which the user controls the displacements via the pointing device (5) (mouse, keyboard, joystick, graphic tablet stylus, etc.), i.e., a materialization of the virtual sensor. The sensory stimulations delivered at each instant to the user are controlled by the state of the environment at each instant at the site of these analysis fields. In general, one analysis field (4) is linked to one sensitive element and thus there are as many analysis fields (4) as there are sensitive elements. The user can select and modulate the number, disposition and form of his analysis fields (4). By the active exploration of the virtual space in which he displaces his analysis fields (4), the user discovers the invariant relationships between his actions (his displacements controlled by the pointing devices (5)) and his sensations (the sensory stimulations that he receives). These are invariant relations which enable the use to constitute the perception (localization and recognition of form) of objects and events in this virtual space.

The body-image (19), illustrated in FIG. 4b, moves with the body-sensor (18). It defines the state of the environment at its position for the analysis fields of other users who share the same virtual space of interaction. The body-image of a user is thus a form in displacement potentially perceptible by other users. Each user can define the form of its body-image. It can be larger, smaller, superposed or offset in relation to the body-sensor (18) defined by the analysis fields (4) as illustrated in FIG. 4c. It is also possible to define a body-image which is nonsymmetrical in all the directions of the space and of which the user controls the orientation. This control can, for example, be implemented with a pointing device (5) such as, for example, a stylus of a graphic tablet which gives the tilt effect, i.e., the orientation and inclination of the stylus.

If the body-sensor and body-image of different users are sufficiently similar, when the analysis fields (4) of the body-sensor (18) of a user covers the body-image (19′) of another user, simultaneously and reciprocally, the analysis fields (4) of the body-sensor (18′) of this second user cover the body-image (19) of the first user as illustrated in FIG. 5.

In this situation, the body-sensors and the body-images are similar and symmetrical when the analysis fields of the body-sensor (18) of a user cover the body-image (19′) of another user, the analysis fields of this latter user cover the body-image (19) of the first user: it is not possible to see without being seen.

In contrast, if the body-images or analysis fields are asymmetrical and orientable, it is possible that the body-sensor (18) of a user could cover the body-image (19′) of another user without the body-sensor (18′) of this latter user covering the body-image (19) of the first user: one can see without being seen as illustrated in FIG. 6.

The value of these perceptive crossings is that in the course of the perceptive activity of different users, each user can recognize not only the presence of a form in displacement but that this form is that of another perceiving user and not a passive form recorded in the environment. That which is given to perceive in such a system are not only things or even bodies, but also the perceptive activity of others, and this in the very particular situation in which this activity is oriented to the perception of the user's perceptive activity itself. There is thereby realized in a very particular perceptive modality a form of remote glance crossing or mutual caress. In fact, although in the example presented below as an example the sensory stimulation is of the tactile type, we can say that there is thereby produced a form of remote touching in the virtual spaces of tactile encounters.

The general condition for the successful outcome of these perceptive interactions is the transmission speed of the information in the network which links the different users via their perceptive interfaces. However, this high speed can easily be attained because the amount of information transmitted at each instant is very small. The forms of the body-sensors and body-images of the different users are transmitted at the beginning of the session and only need to be updated from time to time. The only data that needs to be transmitted rapidly are the information on the positions of the different bodies (x, y, z if the virtual space is three dimensional) and, depending on the case, information on the orientation of the bodies and/or their possible deformations.

The interaction spaces can be structured.

It is possible to trace limits in it. For example, the edge of a space would be defined by a continuous full form which saturates the sensory stimulators.

The users can be authorized to write in the shared space so that they can mutually give each other the perception of forms. An important part of learning the usage of such interfaces advances via sessions comprising writing and reading written forms. This can, for example, also be employed for remote teaching of mathematics to blind subjects.

Moreover, the encounter space can be either a collective space in which a large number of users can interact or be divided into more restricted spaces in which several users can schedule meetings with each other.

The software program enabling implementation of the method according to the invention can be applicable to young blind subjects in math class or for any other teaching situation in which it is necessary to provide comprehension of curves and graphical information. But of course it is also useful for the entire blind public that wants to read graphical information and curves and more generally identify forms, images and even landscapes. It can easily be integrated in existing systems.

The invention was described above as an example. It is understood that the expert in the field could implement different variants of the invention without going beyond the scope of the patent.

1-15 cancelled

16. A method enabling at least one blind user to perceive a form using at least one sensory stimulator comprising: creating at least one virtual sensor having a multiplicity of analysis fields; displacing the virtual sensor with a pointing device on or towards the form; and controlling a sensitive element of the sensory stimulator with each analysis field to enable perception of the form with the sensory stimulator by modifying the state of each sensitive element.

17. The method according to claim 16, wherein form can be implemented by the user with a virtual drawing tool.

18. The method according to claim 16, wherein the form is available via a telecommunication network.

19. The method according to claim 18, wherein each user is defined in or on the form by a body-sensor and by a body-image.

20. The method according to claim 16, wherein the sensitive elements are points for the reading of Braille texts, each of which can move between a retracted position and a raised position, each of the sensitive elements is moved in at least one vibrating state in which they oscillate in a regular manner between the retracted position and the raised position to enable nuancing of the perception of the form.

21. The method according to claim 16, wherein each of the sensitive element(s) has a multiplicity of different vibrating states, each vibrating state being associated with a quantitative variable.

22. The method according to claim 20, wherein each of the sensitive elements has a multiplicity of vibrating states, each oscillation being associated with a color or gray level and/or a distance.

23. The method according to claim 16, wherein the configuration of the virtual sensor can be modified by modification of the relative position of the analysis fields.

24. The method according to claim 16, wherein the analysis fields of the virtual sensor have a general matrix, separated or nested conformation.

25. The method according to claim 16, wherein the analysis fields each have a configuration of a parallelogram, triangle, circle, portion of a circle, parallelepiped, pyramid, sphere or portion of a sphere.

26. A device for implementing the method according to claim 16, comprising a computer with a memory in which the form is contained, the computer being optionally associated with a display screen; a pointing device; and at least one sensory stimulator.

27. The device according to claim 26, wherein the sensory stimulator is a tactile stimulator.

28. The device according to claim 26, wherein the sensory stimulator comprises between 1 and 80 points.

29. The device according to claim 26, wherein the sensory stimulator is a sonorous stimulator.

30. The device according to claim 26, wherein the sensory stimulator is a visual stimulator.
